(19) United States
(12) Patent Application Publication
(10) Pub. No.: US 2015/0062923 A1
(43) Pub. Date: Mar. 5, 2015

(54) Light-Emitting Module and Lighting System

(71) Applicant: Toshiba Lighting & Technology Corporation, Yokosuka-shi (JP)

(72) Inventors: Takaya Kamakura, Yokosuka-shi (JP); Hideaki Shimojo, Yokosuka-shi (JP); Kenichi Asami, Yokosuka-shi (JP); Yoshiyuki Matsunaga, Yokosuka-shi (JP)

(73) Assignee: Toshiba Lighting & Technology Corporation, Yokosuka-shi (JP)

(21) Appl. No.: 14/197,273

(22) Filed: Mar. 5, 2014

(30) Foreign Application Priority Data
Aug. 30, 2013 (JP) 2013-180586

(51) Int. Cl. F21V 5/04; G02B 1/00

(52) U.S. Cl. CPC F21V 5/04; G02B 1/00
USPC 362/311.05; 362/311.03

(57) ABSTRACT

A light-emitting module according to an embodiment includes a light-emitting element which emits light and a substrate on which the light-emitting element is mounted. Further, the light-emitting module according to the embodiment includes a lens, which is formed from a material containing an aliphatic hydrocarbon organic compound having a cyclic structure in the main backbone, and is disposed on the substrate so as to cover the light-emitting element, and in which on a portion irradiated with light emitted by the light-emitting element, the maximum illuminance of the light is 100,000 lx or more and 300,000 lx or less or the maximum energy per unit area of the light is 30,000 μW/cm² or more and 90,000 μW/cm² or less.

### CROSS-REFERENCE TO RELATED APPLICATIONS

This application is based upon and claims the benefit of priorities from Japanese Patent Application No. 2013-180586 filed on Aug. 30, 2013; the entire contents of which are incorporated herein by reference.

### FIELD

Embodiments described herein relate generally to a light-emitting module and a lighting system.

### BACKGROUND

There is known a light-emitting module using a lens formed from an organic material such as a polycarbonate (PC), an acrylic resin, a silicone resin, or an epoxy resin. Further, as a lighting system having a light-emitting module mounted thereon, there is known a lighting system using a cover formed from an organic material as described above.

Recently, the quantity of light emitted from a light-emitting element such as an LED (light-emitting diode) in a light-emitting module is increasing. Therefore, a member such as a lens or a cover formed from an organic material as described above may be sometimes deteriorated (for example, a lens or a cover is discolored or deformed) due to heat and light from a light-emitting element by continuously using a light-emitting module. In this manner, a light-emitting module of the related art and a lighting system including such a light-emitting module have a problem that the heat resistance and the light resistance are not favorable.

An object of the exemplary embodiments is to provide a light-emitting module and a lighting system, each having excellent heat resistance and light resistance.

### BRIEF DESCRIPTION OF THE DRAWINGS

FIG. 1 is a view showing an example of a lighting system.

FIG. 2 is a view showing an example of a light-emitting module according to an embodiment.

FIG. 3 is a graph showing the total light transmittance of a lens.

FIG. 4 is a graph showing the result of a comparative experiment.

FIG. 5 is a graph showing a relationship between an energy per unit area and an illuminance.

FIG. 6 is a view showing an example of a structure of another lighting system having a light-emitting module according to an embodiment mounted thereon.

### DETAILED DESCRIPTION

Hereinafter, a light-emitting module and a lighting system according to embodiments will be described with reference to the accompanying drawings. The light-emitting module and the lighting system described in the following embodiments are merely examples and do not limit the embodiments.

The light-emitting module in the following embodiment includes a light-emitting element which emits light and a substrate on which the light-emitting element is mounted. Further, the light-emitting module in the following embodiment includes a lens, which is formed from a material containing an aliphatic hydrocarbon organic compound having a cyclic structure in the main backbone, and is disposed on the substrate so as to cover the light-emitting element, and in which on a portion irradiated with light emitted by the light-emitting element, the maximum illuminance of the light is 100,000 lx or more and 300,000 lx or less or the maximum energy per unit area of the light is 30,000 μW/cm² or more and 90,000 μW/cm² or less.

Further, in the following embodiment, the lens or the cover has a total light transmittance of 90% or more in the light wavelength range of 350 nm or more and 800 nm or less.

Further, in the following embodiment, the lens or the cover has a glass transition point of 160° C. or higher and 180° C. or lower.

Further, in the following embodiment, the temperature of heat generated in the lens or the cover by light emitted by the light-emitting element is preferably lower than 160° C.

Further, in the following embodiment, the maximum temperature of heat generated in the lens or the cover by light emitted by the light-emitting element is preferably 130° C. or higher and 150° C. or lower.

Further, in the following embodiment, the lens or the cover is formed from a material containing a cycloolefin polymer, a cycloolefin copolymer, or a polynorbornene.

Further, in the following embodiment, the lens or the cover is formed from a material, which contains a cycloolefin polymer, a cycloolefin copolymer, or a polynorbornene as a base material, and is obtained by mixing in the base material, as an antioxidant, a phenolic antioxidant in an amount of 0.05 to 0.5%, as a light stabilizer, a UV absorbent in an amount of 0.1 to 0.2% or a hindered amine light stabilizer in an amount of 0.05 to 0.1%, as a flame retardant, a metal hydroxide in an amount of 10 to 20%, and a silicone additive in an amount of 1 to 10%, wherein each amount is expressed as a percentage relative to the amount of the base material. Here, the base material is, for example, a cycloolefin polymer, a cycloolefin copolymer, or a polynorbornene.

Further, a lighting system according to the following embodiment includes a light-emitting module and a cover, which diffuses light emitted by the light-emitting element, is formed from a material containing an aliphatic hydrocarbon organic compound having a cyclic structure in the main backbone, and in which on a portion irradiated with light emitted by the light-emitting element, the maximum illuminance of the light is 100,000 lx or more and 300,000 lx or less or the maximum energy per unit area of the light is 30,000 μW/cm² or more and 90,000 μW/cm² or less.

Further, in the following embodiment, as the light-emitting element, an LED chip can be used, but the light-emitting element is not limited thereto, and for example, a semiconductor laser or an EL (electroluminescence) element can also be used. When an LED chip is used as the light-emitting element, the luminescent color of the LED chip may be any of red, green, and blue. Further, LED chips having a different luminescent color may be used in combination.

### EMBODIMENTS

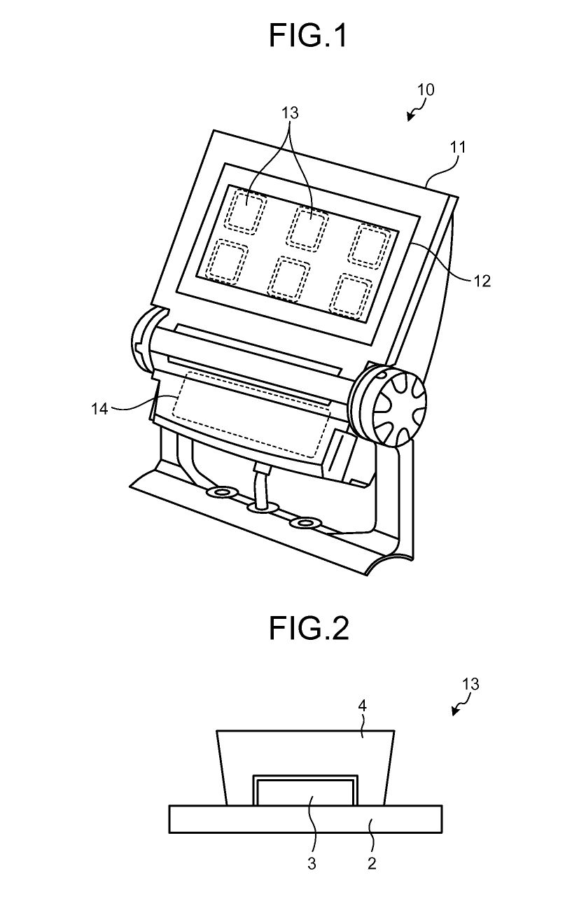

Embodiments of the light-emitting module and the lighting system will be described. FIG. 1 is a view showing an example of a lighting system. In FIG. 1, a lighting system 10 is shown. The lighting system 10 is, for example, a floodlight to be used for lighting up an area. The lighting system 10 includes a device main body 11. The device main body 11 is provided with a floodlight window 12. In the device main body 11, a plurality of light-emitting modules 13 facing the floodlight window 12 are housed. In a lower part of the device main body 11, a lighting device 14 which supplies a lighting electric power to the light-emitting modules 13 is housed. Then, by supplying a lighting electric power to the light-emitting modules 13 from the lighting device 14, the light-emitting modules 13 are lit, and light is emitted from the floodlight window 12.

FIG. 2 is a view showing an example of the light-emitting module 13 according to the embodiment. In FIG. 2, the light-emitting module 13 according to the embodiment is shown. The light-emitting module 13 includes a substrate 2, a light-emitting element 3, and a lens 4.

On the substrate 2, the light-emitting element 3 is mounted. Further, on the substrate 2, a wiring pattern (not shown) is formed, and to this wiring pattern, the light-emitting element 3 is connected. That is, through the wiring pattern, a lighting electric power is supplied to the light-emitting element 3 from the lighting device 14.

As the light-emitting element 3, for example, one having a pair of electrodes on the back surface side such as a flip chip type light-emitting element is used. The pair of electrodes of the light-emitting element 3 are electrically connected to the above-described wiring pattern. The light-emitting element 3 may have a configuration like a face up type light-emitting element such that the light-emitting element 3 has the electrodes on the front surface side, and the electrodes of the light-emitting element 3 are electrically connected to the wiring pattern by wire bonding. The light-emitting element 3 emits light when a lighting electric power is supplied thereto through the wiring pattern.

The lens 4 is provided for controlling light emitted from the light-emitting element 3 and is disposed on the substrate 2 so as to cover the light-emitting element 3. The lens 4 is formed from a material containing an aliphatic hydrocarbon organic compound having a cyclic structure in the main backbone. For example, the lens 4 is formed from a transparent resin, which contains an aliphatic hydrocarbon organic compound having a cyclic structure in the main backbone such as a cycloolefin polymer (COP), a cycloolefin copolymer (COC), or a polynorbornene (PNB) as a base material, and is obtained by mixing in the base material, an additive for absorbing ultraviolet light (a UV absorbent additive), an additive for reducing the yellowish color of the base material, and the like. For example, as the blending ratio of the UV absorbent additive or the additive for reducing the yellowish color of the base material (a bluing agent having the molecular structure of an anthraquinone-based compound) to the base material, 0.1 to 1 ppm with respect to the weight of the base material can be adopted.

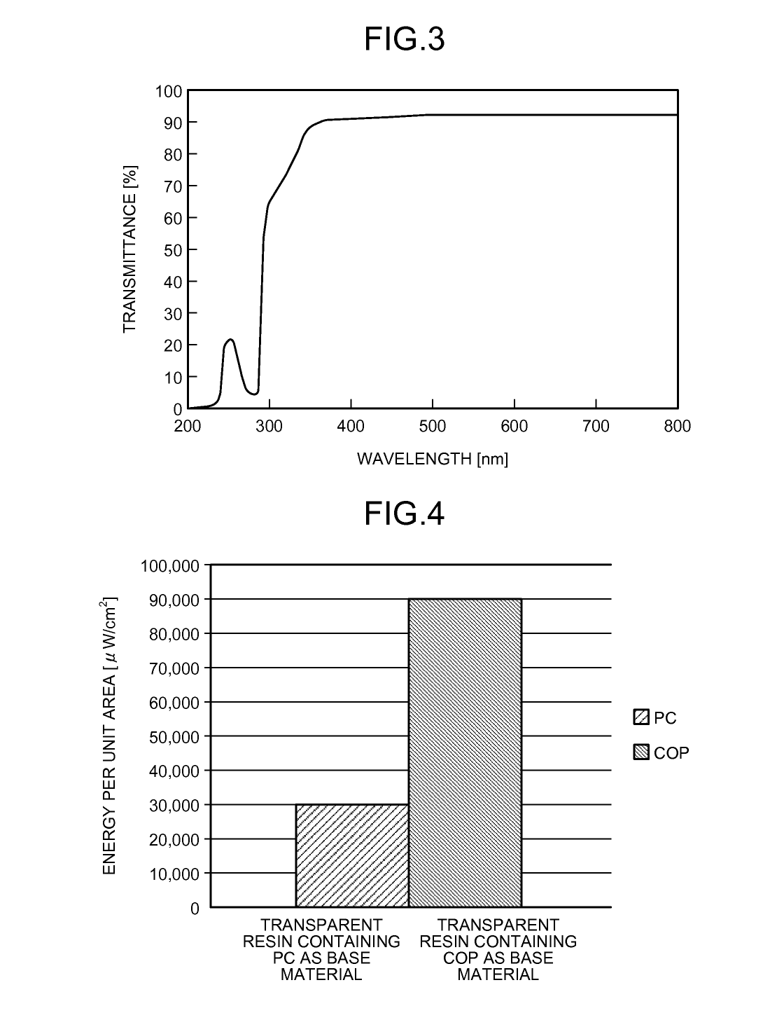

FIG. 3 is a graph showing the total light transmittance of the lens 4. As shown in FIG. 3, the total light transmittance of the lens 4 formed from the material as described above is 90% or more in the light wavelength range of 350 nm or more and 800 nm or less. This shows that the lens 4 has excellent light resistance.

Further, the result of the following comparative experiment between a lens formed from a transparent resin which contains a cycloolefin polymer (COP) as a base material and is obtained by mixing in the base material, a UV absorbent additive, an additive for reducing the yellowish color of the base material, and the like, and a lens of the related art formed from a transparent resin which contains a polycarbonate (PC) as a base material will be described. That is, the result of an experiment, in which each of the two lenses was used in an environment where the temperature of a portion irradiated with light from the light-emitting element was 100° C. during the lifetime (40,000 hours) of the light-emitting module, and the maximum energy per unit area when deterioration did not occur was determined, will be described. Here, the energy per unit area has the same definition as irradiance.

FIG. 4 is a graph showing the result of the comparative experiment. As shown in FIG. 4, in the case of the lens formed from a transparent resin which contains a polycarbonate (PC) as a base material like the related art, the maximum energy per unit area when deterioration did not occur was 30,000 μW/cm². On the other hand, in the case of the lens formed from a transparent resin which contains a cycloolefin polymer (COP) as a base material, the maximum energy per unit area when deterioration did not occur was 90,000 μW/cm². Also this experimental result shows that the lens 4 has higher light resistance than the lens of the related art. Further, the result of the comparative experiment shown in FIG. 4 shows that when the energy per unit area of light on the lens irradiated with light emitted from the light-emitting element is within the range of 30,000 μW/cm² or more and 90,000 μW/cm² or less, it is preferable to use the lens 4 according to the embodiment as the lens of the light-emitting module. On the other hand, the experimental result shows that when the energy per unit area of light on the lens irradiated with light emitted from the light-emitting element is less than 30,000 μW/cm², it is preferable to use a lens which is formed from a transparent resin containing a polycarbonate (PC) as a base material and is less expensive than the lens 4 as the lens of the light-emitting module. Incidentally, when the energy per unit area of light on the lens irradiated with light emitted from the light-emitting element is more than 90,000 μW/cm², for example, it is preferable to use a lens formed from a glass as the lens of the light-emitting module.

FIG. 5 is a graph showing a relationship between an energy per unit area and an illuminance. In the example shown in FIG. 5, the abscissa represents an energy per unit area (μW/cm²), and the ordinate represents an illuminance (lx). As shown in FIG. 5, the illuminance and the energy per unit area are in a one-to-one correspondence. For example, as shown in FIG. 5, when the energy per unit area is 30,000 μW/cm², the illuminance is 100,000 lx, and when the energy per unit area is 90,000 μW/cm², the illuminance is 300,000 lx. Therefore, when producing the light-emitting module, in a step of determining the type of lens to be used in the light-emitting module, the illuminance of light emitted from the light-emitting element is measured using a illuminometer at a position where the lens is planned to be disposed, and if the illuminance obtained by the measurement is less than 100,000 lx, a lens formed from a transparent resin containing a polycarbonate (PC) as a base material may be determined to be used as the lens of the light-emitting module. Further, if the illuminance obtained by the measurement is 100,000 lx or more and 300,000 lx or less, the lens 4 according to the embodiment may be determined to be used as the lens of the light-emitting module. Further, if the illuminance obtained by the measurement is more than 300,000 lx, a lens formed from a glass may be determined to be used as the lens of the light-emitting module.

Further, the lens 4 has a characteristic that the glass transition point is 160° C. or higher and 180° C. or lower. This shows that the lens 4 also has heat resistance. Further, since the lens 4 has this characteristic, the temperature of heat generated in the lens 4 by light emitted by the light-emitting element 3 is preferably lower than 160° C. However, when the temperature of heat generated therein is too low, if a lens formed from a transparent resin containing a polycarbonate (PC) as a base material is not used, but the lens 4 according to the embodiment is used, the cost is wasted. Accordingly, when the maximum temperature of heat generated in the lens 4 by light emitted by the light-emitting element 3 is 130° C. or higher and 150° C. or lower, it is preferable to use the lens.

Hereinabove, the light-emitting module 13 and the lighting system 10 of the embodiments are described. The light-emitting module 13 of the embodiment includes the light-emitting element 3 which emits light and the substrate 2 on which the light-emitting element 3 is mounted. Further, the light-emitting module 13 of the embodiment includes the lens 4, which is formed from a material containing an aliphatic hydrocarbon organic compound having a cyclic structure in the main backbone, and is disposed on the substrate 2 so as to cover the light-emitting element 3. Here, when on a portion of the lens 4 irradiated with light emitted by the light-emitting element 3, the maximum illuminance is 300,000 lx or less or the maximum energy per unit area of the light is 90,000 μW/cm² or less, as shown by the result of the comparative experiment in FIG. 4 and the graph in FIG. 5, the lens 4 is not deteriorated under the actual use conditions during the lifetime (40,000 hours) of the light-emitting module 13. In this manner, the light-emitting module 13 of the embodiment has excellent heat resistance and light resistance.

When on a portion of a lens irradiated with light emitted by the light-emitting element 3, the maximum illuminance is 100,000 lx or more and 300,000 lx or less or the maximum energy per unit area of the light is 30,000 μW/cm² or more and 90,000 μW/cm² or less, it is preferable to use the lens 4 as the lens of the light-emitting module 13. Further, when on a portion of a lens irradiated with light emitted by the light-emitting element 3, the maximum illuminance is less than 100,000 lx or the maximum energy per unit area of the light is less than 30,000 μW/cm², it is preferable to use a lens formed from a material containing a polycarbonate (PC) as the lens of the light-emitting module 13. By doing this, from the viewpoint of cost such as expense, an appropriate type of lens can be used in the light-emitting module 13.

Incidentally, when a cover for diffusing light emitted from the light-emitting element 3 is used as a member such as the floodlight window 12 of the lighting system 10, the cover can also be formed from the same material as the above-described material for forming the lens 4.

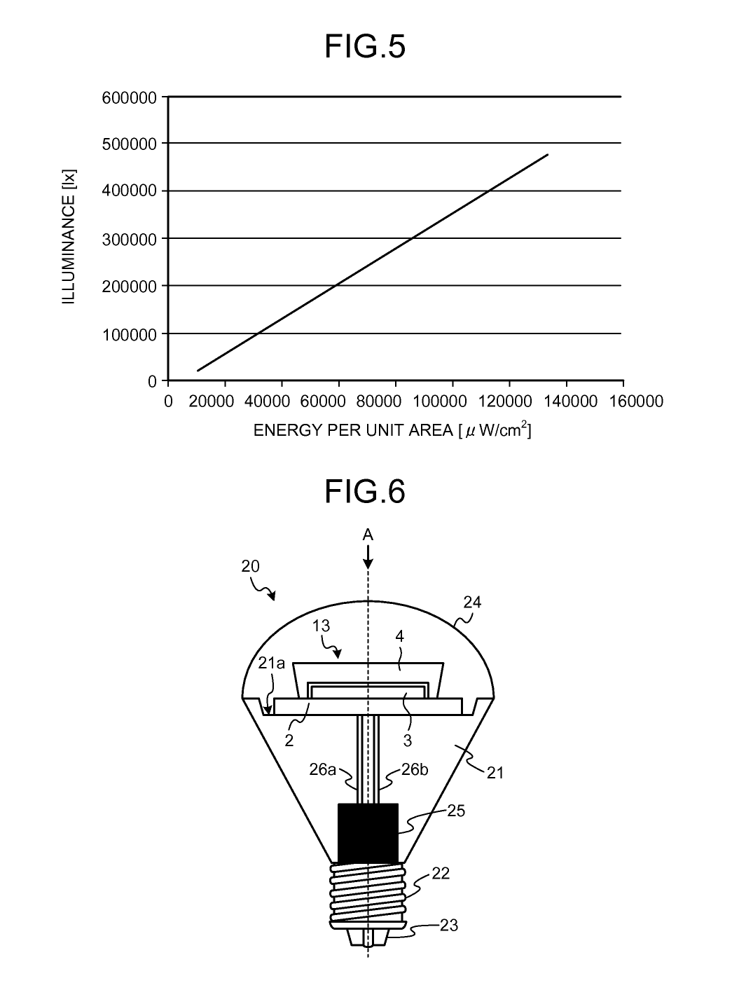

The above-described light-emitting module 13 can also be applied to a lighting system other than the lighting system 10. FIG. 6 is a view showing an example of a structure of another lighting system having the light-emitting module 13 according to the embodiment mounted thereon. A lighting system 20 shown in FIG. 6 includes the light-emitting module 13, a main body 21, a cap member 22, an eyelet portion 23, a cover 24, a control section 25, and electric wirings 26a and 26b. The light-emitting module 13 is disposed on the upper surface 21a of the main body 21.

The main body 21 is formed into a cylindrical shape having a substantially circular cross section from a metal having a high heat conductivity such as aluminum. Further, the cap member 22 is attached to one end of the main body 21, and to the other end of the main body 21, the cover 24 for diffusing light emitted from the light-emitting module 13 is attached. The cover 24 is formed from the same material as the above-described material for forming the lens 4. Further, the main body 21 is formed to have a substantially conical tapered surface such that the diameter of the outer peripheral surface thereof is continuously increased from one end to the other end.

Further, the main body 21 is formed into a shape close to the silhouette of a neck portion of a mini krypton bulb. Incidentally, on the outer peripheral surface of the main body 21, many thermal radiation fins (not shown) protruding radially from one end to the other end are integrally formed.

The cap member 22 is, for example, an Edison type E-shaped cap, and includes a cylindrical shell made of a copper plate having threads. Further, the cap member 22 has the conductive eyelet portion 23 which is disposed at the top of the lower end of the shell through an electrically insulating portion. The opening of the shell is fixed to the opening at one end of the main body 21 in an electrically insulated manner.

To the shell and the eyelet portion 23, an input line extracted from a power input terminal of a circuit board (not shown) in the control section 25 is connected. Such a cap member 22 is inserted into, for example, a socket provided on the ceiling or the like, and thereby an electric power supplied from a commercial power supply is supplied to the control section 25.

The cover 24 is formed from, for example, a milky white polycarbonate. Further, the cover 24 is formed into a smooth curved surface shape close to the silhouette of a mini krypton bulb having an opening at one end. The cover 24 is fixed to the main body 21 by fitting the end of the opening in the main body 21 so as to cover the light-emitting surface of the light-emitting module 13. The method for fixing the cover 24 to the main body 21 may be any of adhering, fitting, screwing, locking, and the like.

The control section 25 supplies an electric power to the light-emitting module 13 and controls the turning on and off of the light-emitting module 13. The control section 25 has a control circuit which is stored so as to be electrically insulated from the outside. The control section 25 converts an AC voltage to a DC voltage by the control of the control circuit, and applies the DC voltage obtained by the conversion to the light-emitting module 13. Further, to an output terminal of the control circuit of the control section 25, the electric wirings 26a and 26b for supplying electricity to the light-emitting module 13 are connected.

The electric wirings 26a and 26b are guided to the opening at the other end of the main body 21 through a through-hole (not shown) and a guide groove (not shown) formed in the main body 21. The tip portions of the electric wirings 26a and 26b are connected to a connector (not shown) after an insulating coat is peeled off from the tip portions.

In this manner, the control section 25 supplies an electric power input through the shell and the eyelet portion 23 to the light-emitting module 13 through the electric wirings 26a and 26b. Then, the control section 25 recovers the electric power supplied to the light-emitting module 13 through the electric wirings 26a and 26b.

As described above, according to the above-described embodiments, the heat resistance and the light resistance can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light-emitting module comprising:
a light-emitting element which emits light;
a substrate on which the light-emitting element is mounted; and
a lens, which is formed from a material containing an aliphatic hydrocarbon organic compound having a cyclic structure in the main backbone, and is disposed on the substrate so as to cover the light-emitting element, and in which on a portion irradiated with light emitted by the light-emitting element, the maximum illuminance of the light is 100,000 lx or more and 300,000 lx or less or the maximum energy per unit area of the light is 30,000 μW/cm² or more and 90,000 μW/cm² or less.

2. The module according to claim 1, wherein the lens has a total light transmittance of 90% or more in the light wavelength range of 350 nm or more and 800 nm or less.

3. The module according to claim 1, wherein the lens has a glass transition point of 160° C. or higher and 180° C. or lower.

4. The module according to claim 3, wherein the temperature of heat generated in the lens by light emitted by the light-emitting element is lower than 160° C.

5. The module according to claim 3, wherein the maximum temperature of heat generated in the lens by light emitted by the light-emitting element is 130° C. or higher and 150° C. or lower.

6. The module according to claim 1, wherein the lens is formed from a material containing a cycloolefin polymer, a cycloolefin copolymer, or a polynorbornene.

7. The module according to claim 1, wherein the lens is formed from a material, which contains a cycloolefin polymer, a cycloolefin copolymer, or a polynorbornene as a base material, and is obtained by mixing in the base material, as an antioxidant, a phenolic antioxidant in an amount of 0.05 to 0.5%, as a light stabilizer, a UV absorbent in an amount of 0.1 to 0.2% or a hindered amine light stabilizer in an amount of 0.05 to 0.1%, as a flame retardant, a metal hydroxide in an amount of 10 to 20%, and a silicone additive in an amount of 1 to 10%, wherein each amount is expressed as a percentage relative to the amount of the base material.

8. A lighting system comprising:
a light-emitting module including a light-emitting element which emits light, a substrate on which the light-emitting element is mounted, and a lens, which is formed from a material containing an aliphatic hydrocarbon organic compound having a cyclic structure in the main backbone, and is disposed on the substrate so as to cover the light-emitting element, and in which on a portion irradiated with light emitted by the light-emitting element, the maximum illuminance of the light is 100,000 lx or more and 300,000 lx or less or the maximum energy per unit area of the light is 30,000 μW/cm² or more and 90,000 μW/cm² or less; and
a cover, which diffuses light emitted by the light-emitting element, is formed from a material containing an aliphatic hydrocarbon organic compound having a cyclic structure in the main backbone, and in which on a portion irradiated with light emitted by the light-emitting element, the maximum illuminance of the light is 100,000 lx or more and 300,000 lx or less or the maximum energy per unit area of the light is 30,000 μW/cm² or more and 90,000 μW/cm² or less.

9. The system according to claim 8, wherein at least one of the lens and the cover has a total light transmittance of 90% or more in the light wavelength range of 350 nm or more and 800 nm or less.

10. The system according to claim 8, wherein at least one of the lens and the cover has a glass transition point of 160° C. or higher and 180° C. or lower.

11. The system according to claim 10, wherein the temperature of heat generated in at least one of the lens and the cover by light emitted by the light-emitting element is lower than 160° C.

12. The system according to claim 10, wherein the maximum temperature of heat generated in at least one of the lens and the cover by light emitted by the light-emitting element is 130° C. or higher and 150° C. or lower.

13. The system according to claim 8, wherein at least one of the lens and the cover is formed from a material containing a cycloolefin polymer, a cycloolefin copolymer, or a polynorbornene.

14. The system according to claim 8, wherein at least one of the lens and the cover is formed from a material, which contains a cycloolefin polymer, a cycloolefin copolymer, or a polynorbornene as a base material, and is obtained by mixing in the base material, as an antioxidant, a phenolic antioxidant in an amount of 0.05 to 0.5%, as a light stabilizer, a UV absorbent in an amount of 0.1 to 0.2% or a hindered amine light stabilizer in an amount of 0.05 to 0.1%, as a flame retardant, a metal hydroxide in an amount of 10 to 20%, and a silicone additive in an amount of 1 to 10%, wherein each amount is expressed as a percentage relative to the amount of the base material.
